(19) United States
(12) Patent Application Publication
(10) Pub. No.: US 2015/0135923 A1
(43) Pub. Date: May 21, 2015

(54) Detachable Protective Device for a Table Saw

(71) Applicant: Chih Hung Liao, Taichung City (TW)

(72) Inventor: Chih Hung Liao, Taichung City (TW)

(21) Appl. No.: 14/494,662

(22) Filed: Sep. 24, 2014

(30) Foreign Application Priority Data
Nov. 15, 2013 (CN) 201320725349.2

(51) Int. Cl. B27G 19/02

(52) U.S. Cl. CPC B27G 19/02
USPC 83/478

(57) ABSTRACT

A detachable protective device for a table saw includes a cutter board having first and second recesses. The second recess includes a receiving portion having a first width and a neck having a second width smaller than the first width. A base is mounted to the cutter board and includes first and second holes. A pivot is mounted in the first hole and is releasably engaged with the first recess. A locking member includes a pivotal portion pivotably received in the second hole. The pivotal portion has a maximal width larger than the second width and not larger than the first width and has a minimal width not larger than the second width. The pivotal portion is retained in the second recess when the locking member is in the locking position. The pivotal portion can disengage from the second recess when the locking member is in the release position.

### BACKGROUND OF THE INVENTION

The present invention relates to a protective device for a table saw and, more particularly, to a detachable protective device that can rapidly be assembled to or detached from a table saw by pivoting a locking device.

China Patent No. CN201067820 discloses a shield pivotably mounted to a cover of a table saw. An end of the cover is fixed above a mounting seat of a quick release device. A positioning pin is mounted in a positioning hole of the mounting seat. The positioning pin can be moved in an axial direction to selectively engage with or disengage from a through-hole in a cutter board. The positioning pin is positioned by a positioning assembly. Thus, the mounting seat can rapidly be mounted to or detached from the cutter board, permitting rapid attachment or detachment of the shield.

However, rapid mounting and rapid detachment of the shield are achieved by moving the positioning pin in a transverse direction of the cutter board and by extending the positioning pin into the through-hole in the cutter board. A user must use both hands while mounting or detaching the shield in which one of the hands controls the positioning pin, and the other moves the shield. Thus, the user has to raise or lower the shield with only one hand, which is inconvenient. Furthermore, the user has to apply a force to compensate the force for moving the positioning pin in the transverse direction while moving the shield. Otherwise, the shield will deviate in the transverse direction, which, in turn, squeezes and bends the cutter board, leading to deformation of the cutter board.

### BRIEF SUMMARY OF THE INVENTION

A detachable protective device for a table saw according to the present invention includes a cutter board including a top end having a first recess and a second recess. The second recess includes a receiving portion and a neck. The receiving portion is located in an inner side of the second recess. The neck is located in an outer side of the second recess. The receiving portion has a first width. The neck has a second width smaller than the first width. A base is mounted to the top end of the cutter board. The base includes a bracket, a pivot, and a locking member. The bracket includes a first hole and a second hole. The pivot is mounted in the first hole and is releasably engaged with the first recess. The locking member includes a pivotal portion received in the second hole and releasably engaged with the second recess. The locking member is pivotable relative to the bracket between a locking position and a release position about a pivotal axis. The pivotal portion has a maximal width orthogonal to the pivotal axis. The maximal width is larger than the second width and is not larger than the first width. The pivotal portion has a minimal width orthogonal to the pivotal axis. The minimal width is not larger than the second width. The pivotal portion is retained in the second recess when the locking member is in the locking position. The pivotal portion is capable of disengaging from the second recess when the locking member is in the release position. The bracket further includes an abutment portion. The locking member further includes a limiting portion. The limiting portion abuts the abutment portion when the locking member is in the locking position. The limiting portion disengages from the abutment portion when the locking member is in the release position. Two shields are mounted to two sides of the base.

The bracket can further include a receptacle. An elastic element and a positioning member are received in the receptacle. The limiting portion of the locking member includes a first positioning groove and a second positioning groove. The positioning member is biased by the elastic element to be selectively engaged with one of the first and second positioning grooves. The positioning member engages with the first positioning groove when the locking member is in the locking position. The positioning member engages with the second positioning groove when the locking member is in the release position.

The first hole can be parallel to the second hole. The second hole can be formed in a side of the bracket. The abutment portion and the receptacle can be located on the side of the bracket.

The pivotal portion can include two evasive faces, and the minimal width is a spacing between the two evasive faces.

In an example, the maximal width is equal to the first width, and the minimal width is equal to the second width.

The first recess can be located adjacent to a rear end of the cutter board. The second recess can be located adjacent to a front end of the cutter board. Each of the first and second recesses can extend from a side of the cutter board through another side of the cutter board.

The first recess can be substantially L-shaped.

In an example, the pivotal portion can be substantially cylindrical. The limiting portion is located on an end of the pivotal portion. The locking member is integrally formed as a monolithic member.

The base can further include two arms pivotably mounted to two sides of the bracket. Each of the two arms has an end distant to the bracket. Each of the two shields is pivotably mounted to the end of one of the two arms.

The base can further include a ratchet plate pivotably mounted to each of two sides of the bracket.

The present invention will become clearer in light of the following detailed description of illustrative embodiments of this invention described in connection with the drawings.

### DESCRIPTION OF THE DRAWINGS

FIG. 1 is a perspective view of a table saw and a detachable protective device according to the present invention mounted to the table saw.

FIG. 2 is an exploded, perspective view of the detachable protective device and a portion of the table saw of FIG. 1.

FIG. 3 is a cross sectional view taken along section line 3-3 of FIG. 1.

FIG. 4 is an enlarged view of a circled portion of FIG. 3.

FIG. 5 is an enlarged, exploded, perspective view of a portion of the detachable protective device of FIG. 1.

FIG. 6 is another enlarged, exploded, perspective view of the portion of the detachable protective device of FIG. 5.

FIG. 7 is a cross sectional view taken along section line 7-7 of FIG. 3.

FIG. 8 is a view similar to FIG. 4, illustrating detachment of the detachable protective device.

FIG. 9 is a view similar to FIG. 3, illustrating detachment of the detachable protective device.

FIG. 10 is a perspective view of the detachable protective device and the table saw of FIG. 1 for cutting a board.

FIG. 11 is a perspective view similar to FIG. 10 with the board cut.

### DETAILED DESCRIPTION OF THE INVENTION

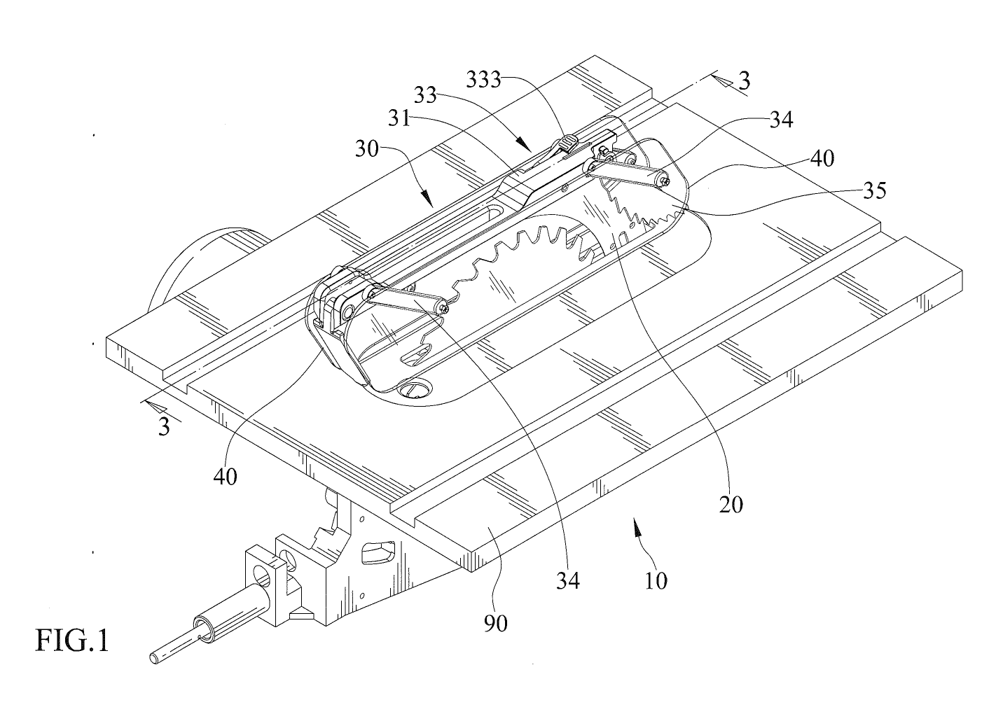

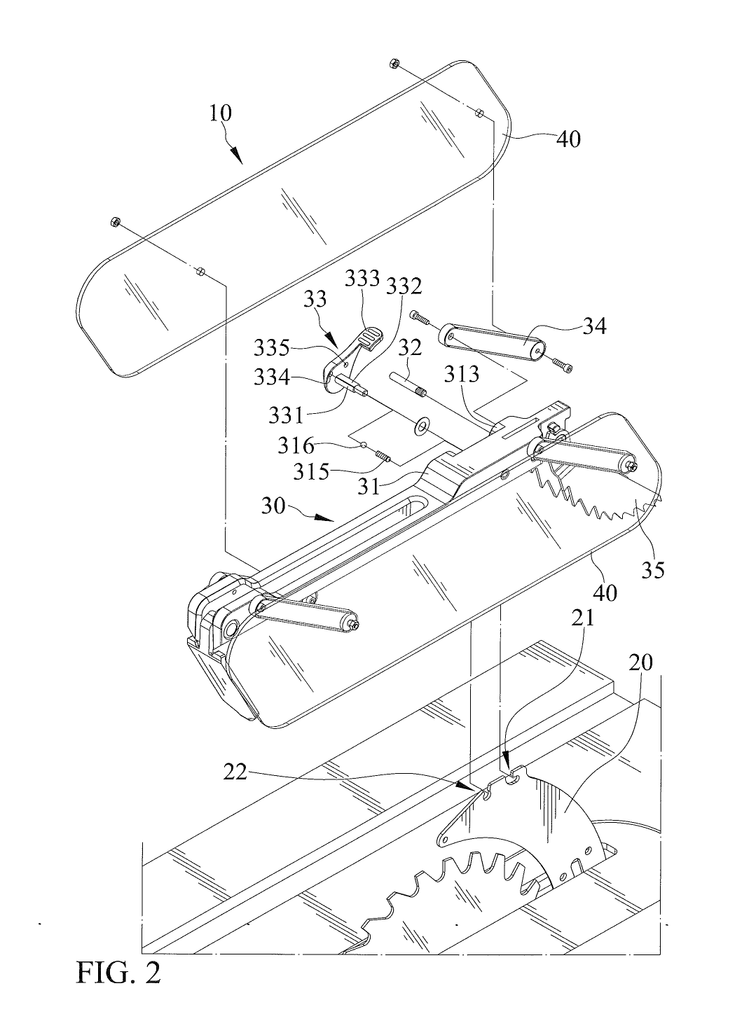

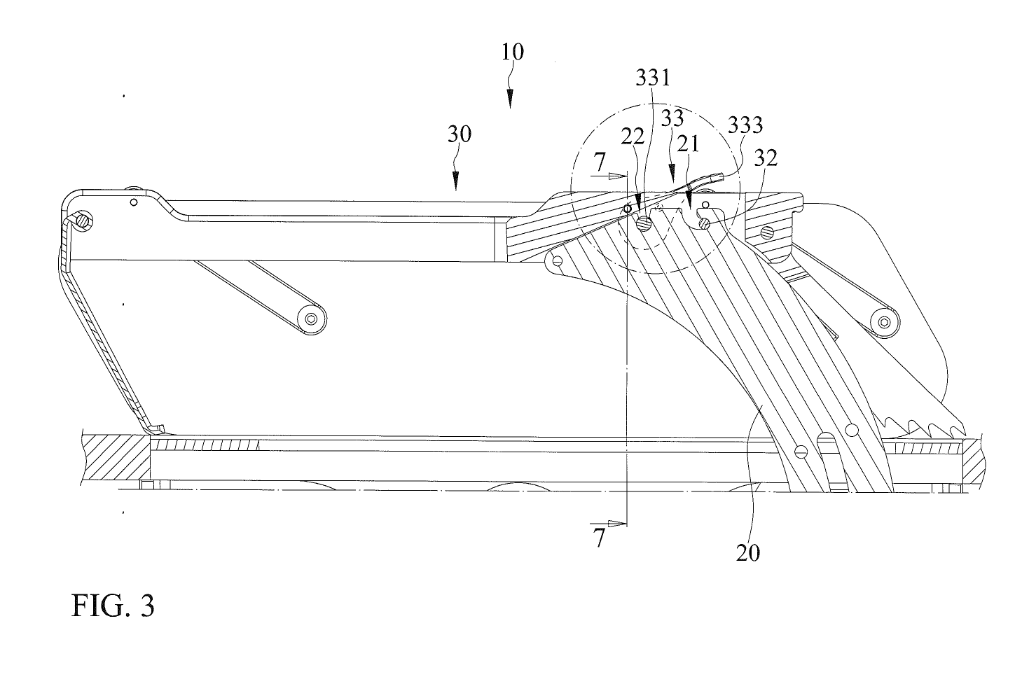

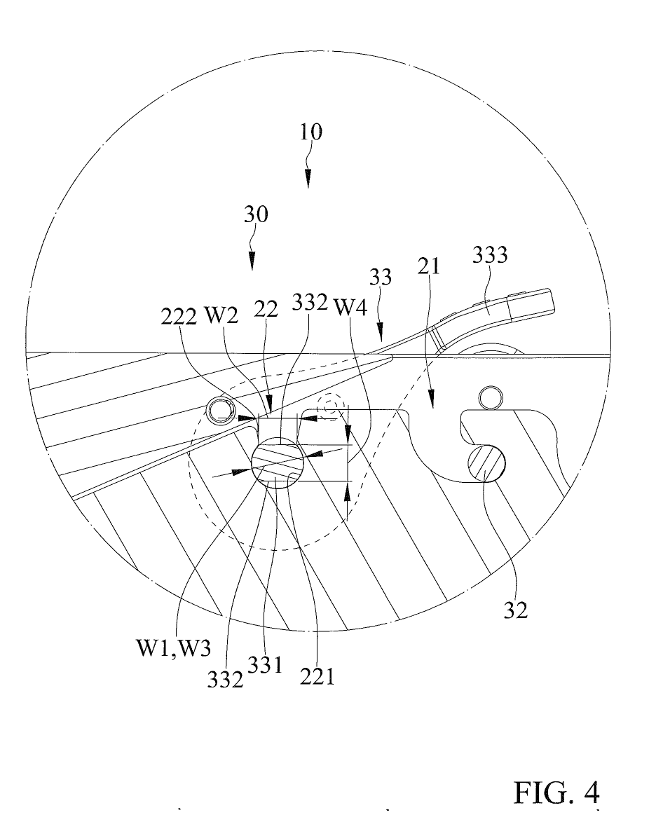

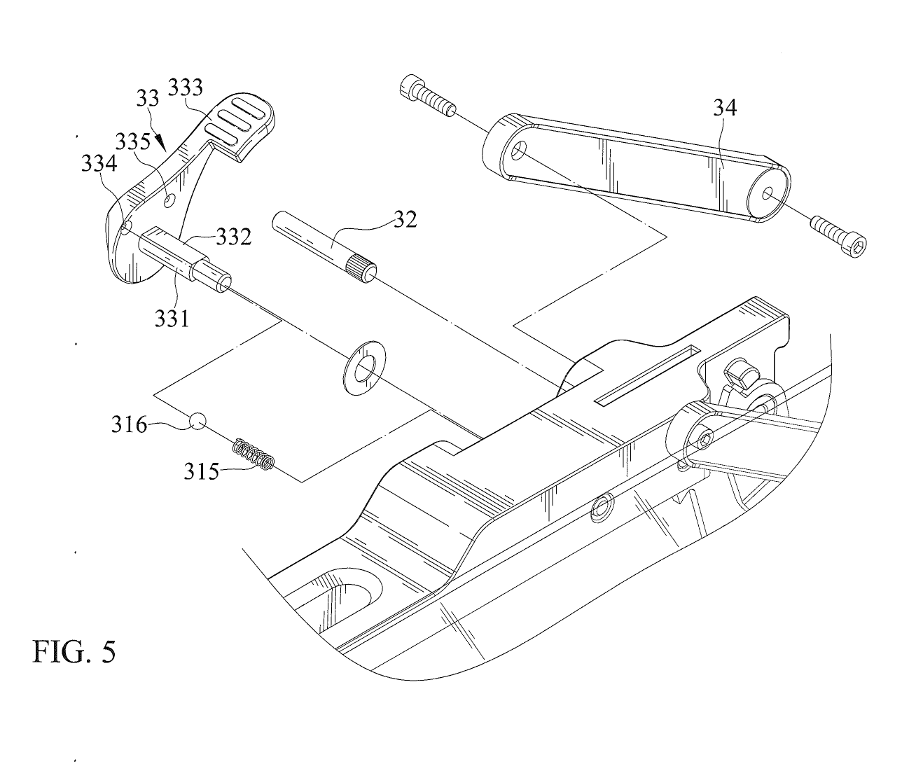

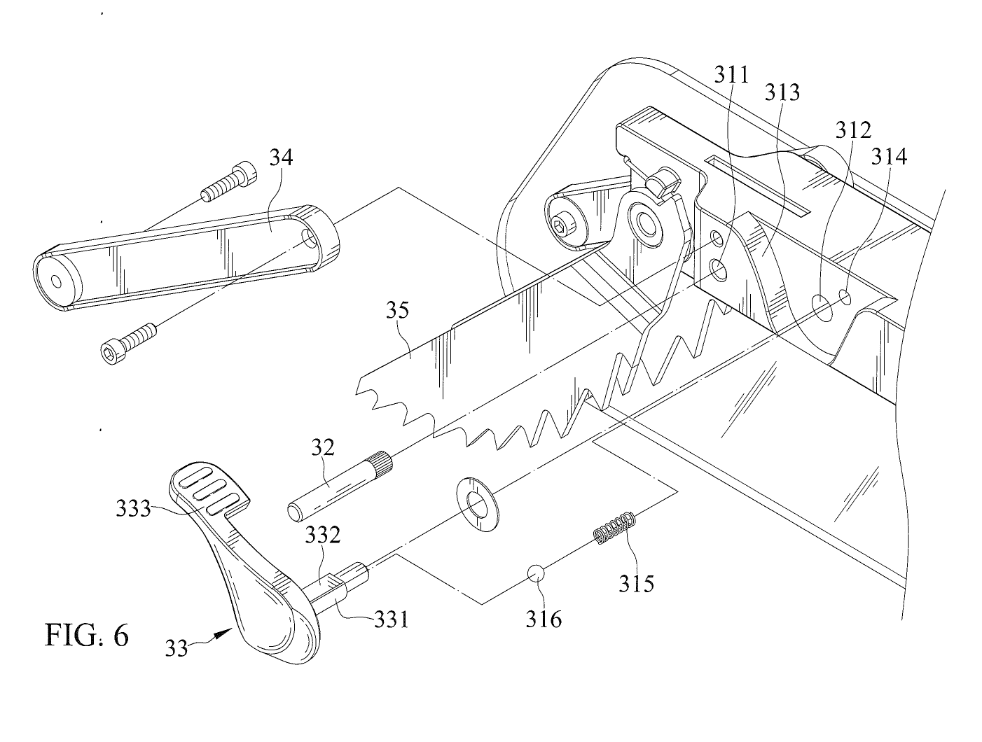

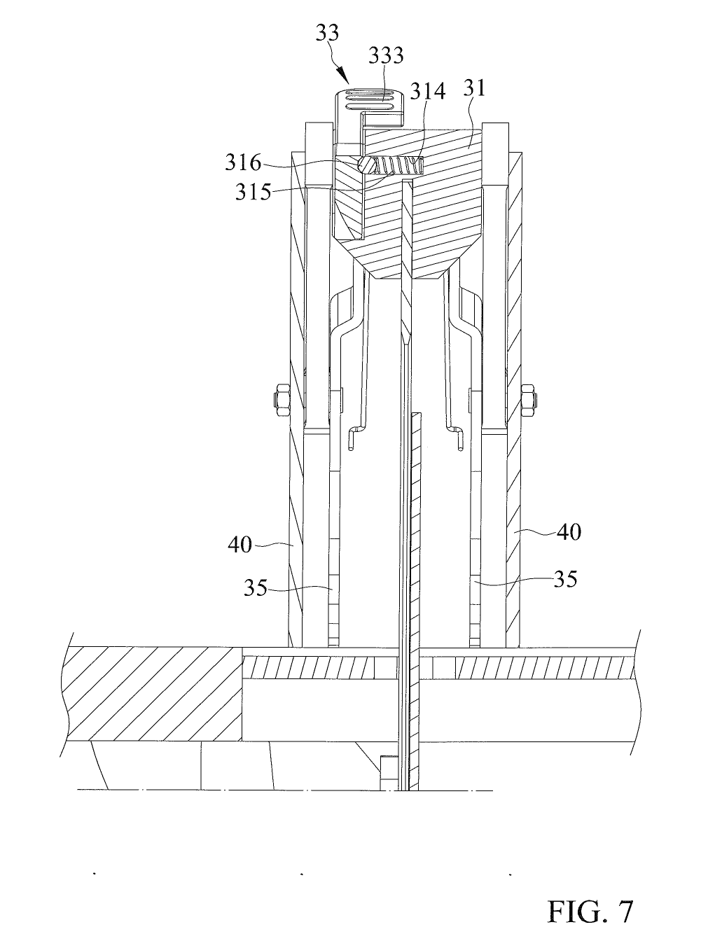

A detachable protective device 10 for a table saw according to the present invention is shown in FIGS. 1-11 and generally includes a cutter board 20, a base 30, and two shields 40.

The cutter board 20 includes a bottom end connected to a table saw 90. The cutter board 20 further includes a top end having a first recess 21 and a second recess 22. The first recess 21 is located adjacent to a rear end of the cutter board 20. The second recess 22 is located adjacent to a front end of the cutter board 20. Each of the first and second recesses 21 and 22 extend from a side of the cutter board 20 through the other side of the cutter board 20. The first recess 21 is substantially L-shaped. The second recess 22 includes a receiving portion 221 and a neck 222. The receiving portion 221 is located in an inner side of the second recess 22. The neck 222 is located in an outer side of the second recess 22. The receiving portion 221 has a first width W1. The neck 222 has a second width W2 smaller than the first width W1.

The base 30 is mounted to the top end of the cutter board 20. The base 30 includes a bracket 31, a pivot 32, and a locking member 33. The bracket 31 includes a first hole 311 and a second hole 312 parallel to the first hole 311. The second hole 312 is formed in a side of the bracket 31. The bracket 31 further includes an abutment portion 313 and a receptacle 314. The abutment portion 313 and the receptacle 314 are located on the side of the bracket 31. An elastic element 315 and a positioning member 316 are received in the receptacle 314. The elastic element 315 is located in an inner side of the receptacle 314. The positioning member 316 is located in an outer side of the receptacle 314.

The pivot 32 is received in the first hole 311 and is releasably engaged with the first recess 21. The locking member 33 is integrally formed as a monolithic member. The locking member 33 includes a pivotal portion 331 that is substantially cylindrical. The pivotal portion 331 is received in the second hole 312 and is releasably engaged with the second recess 22. The locking member 33 is pivotable relative to the bracket 31 between a locking position and a release position about a pivotal axis. The pivotal portion 331 has a maximal width W3 orthogonal to the pivotal axis. The maximal width W3 is larger than the second width W2 and is not larger than the first width W1. In this embodiment, the maximal width W3 is equal to the first width W1. The pivotal portion 331 includes at least one evasive face 332. In this embodiment, the pivotal portion 331 includes two invasive faces 332 to provide a minimal width W4 orthogonal to the pivotal axis. The minimal width W4 is the spacing between the invasive faces 332 and is not larger than the second width W2. In this embodiment, the minimal width W4 is equal to the second width W2.

The pivotal portion 331 is retained in the second recess 22 when the locking member 33 is in the locking position. The pivotal portion 331 is capable of disengaging from the second recess 22 when the locking member 33 is in the release position.

The locking member 33 further includes a limiting portion 333 located on an end of the pivotal portion 331. The limiting portion 333 abuts the abutment portion 313 when the locking member 33 is in the locking position. The limiting portion 333 disengages from the abutment portion 313 when the locking member 33 is in the release position. The limiting portion 333 of the locking member 33 includes a first positioning groove 334 and a second positioning groove 335. The positioning member 316 is biased by the elastic element 315 to be selectively engaged with one of the first and second positioning grooves 334 and 335. The positioning member 316 engages with the first positioning groove 334 when the locking member 33 is in the locking position. The positioning member 316 engages with the second positioning groove 335 when the locking member 33 is in the release position.

The base 30 further includes two arms 34 pivotably mounted to two sides of the bracket 31. Each arm 34 has an end distant to the bracket 31. The two shields 40 are mounted to two sides of the base 30. Each shield 40 is pivotably mounted to the end of one of the two arms 34. The base 30 further includes a ratchet plate 35 pivotably mounted to each of two sides of the bracket 31.

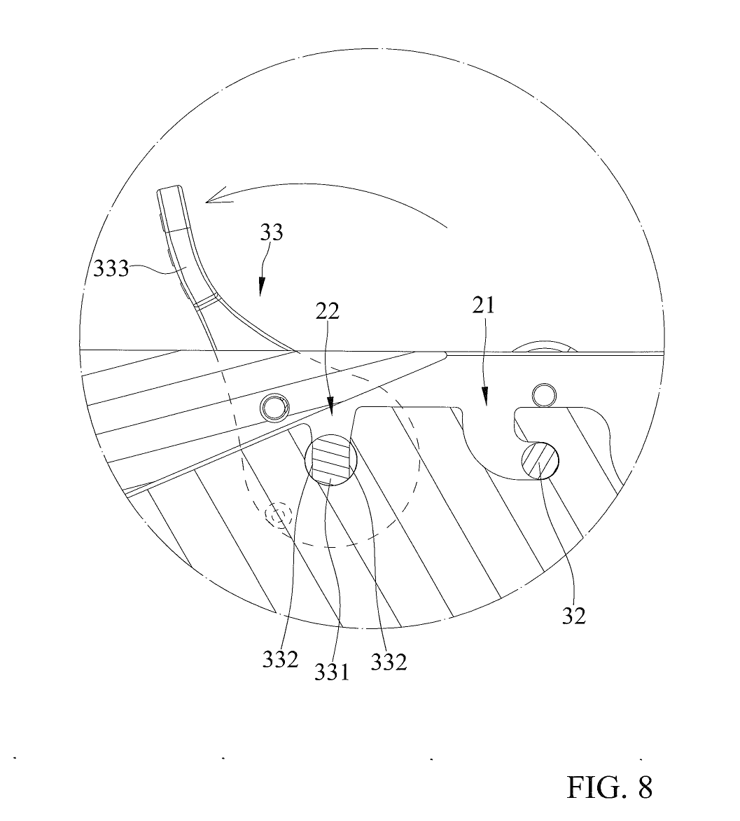

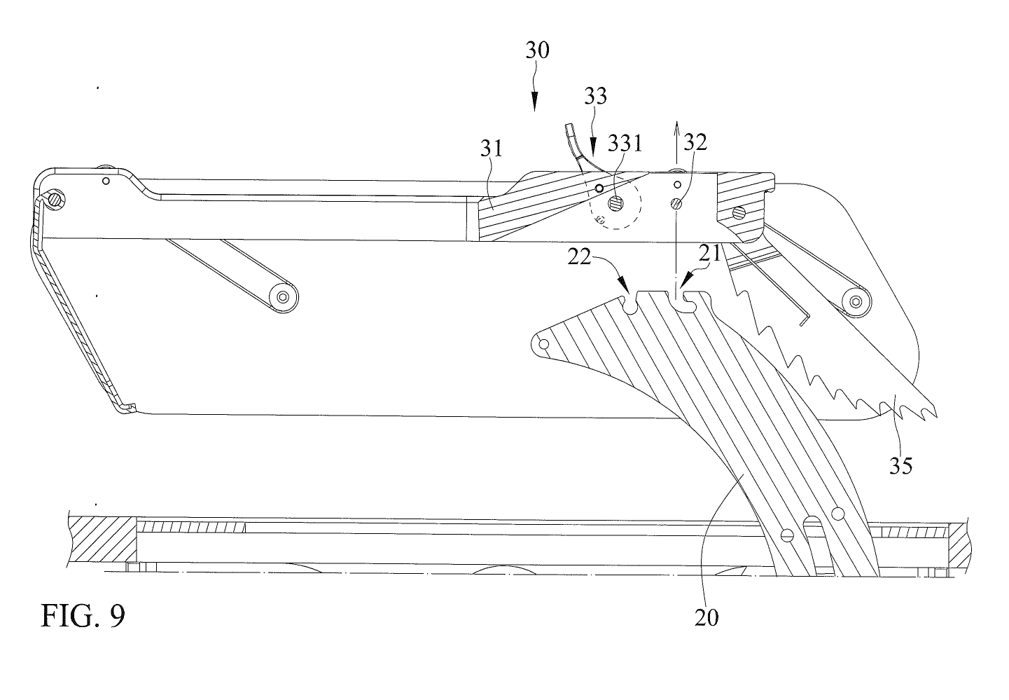

When the locking member 33 is in the locking position, the pivotal portion 331 is retained in the second recess 22. Since the first recess 21 is substantially L-shaped, the pivot 32 is also retained in the first recess 21 and, thus, cannot move relative to the cutter board 20. With reference to FIGS. 8 and 9, when the locking member 33 is pivoted to the release position, the limiting portion 333 disengages from the abutment portion 313. The positioning member 316 engages with the second positioning groove 335. The minimal width W4 of the pivotal portion 331 is aligned with the neck 222. Thus, the pivotal portion 331 of the locking member 33 can disengage from the second recess 22. After the pivotal portion 331 disengages from the second recess 22, the pivot 32 can move relative to the cutter board 20 to disengage from the first recess 21, allowing detachment of the base 30 from the cutter board 20.

While the locking member 33 switches between the locking position and the release position, the positioning member 316 can selectively engage with the first positioning groove 334 or the second positioning groove 335. Thus, the locking member 33 can be retained in either position, avoiding risks resulting from detachment of the base 30 from the cutter board 20 during operation of the table jaw 90. Furthermore, a user can acknowledge the position of the locking member. Specifically, the user can feel whether the locking member 33 is accurately in the locking position or the release position by the touch of the hand during operation of the locking member 33. Furthermore, after the base 30 has been mounted to the cutter board 20, since the limiting portion 333 abuts the abutment portion 313 when the locking member 33 is in the locking position, the locking member 33 can reliably retained in the locking position by pressing the locking member 33 until it is stopped, allowing easy installation of the detachable protective device 10.

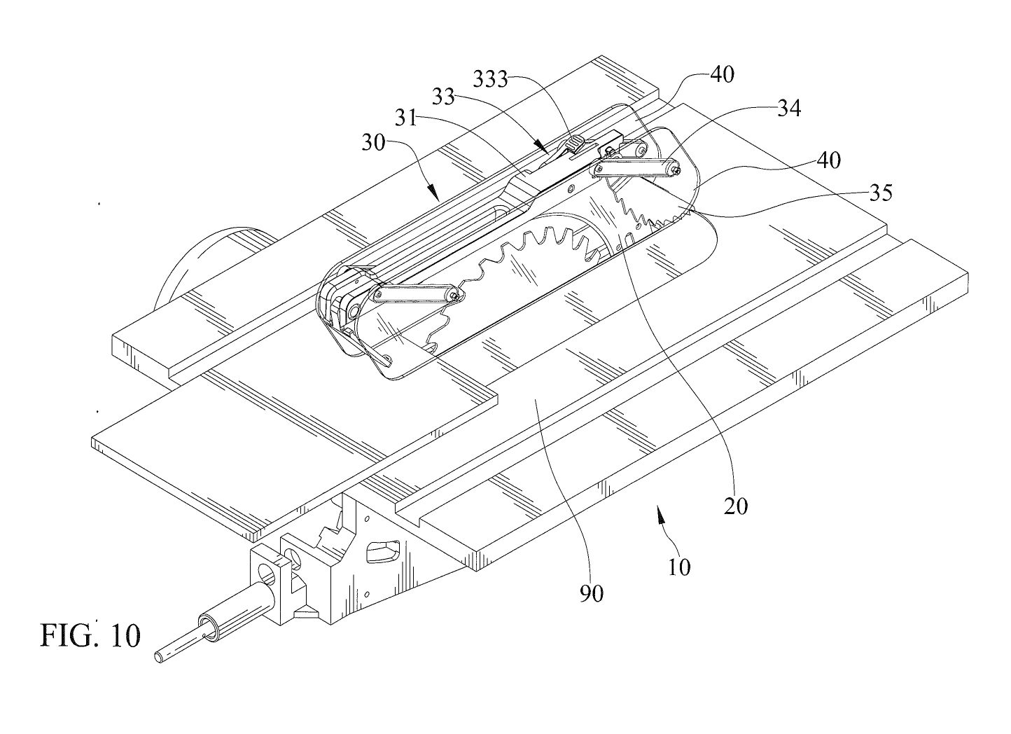

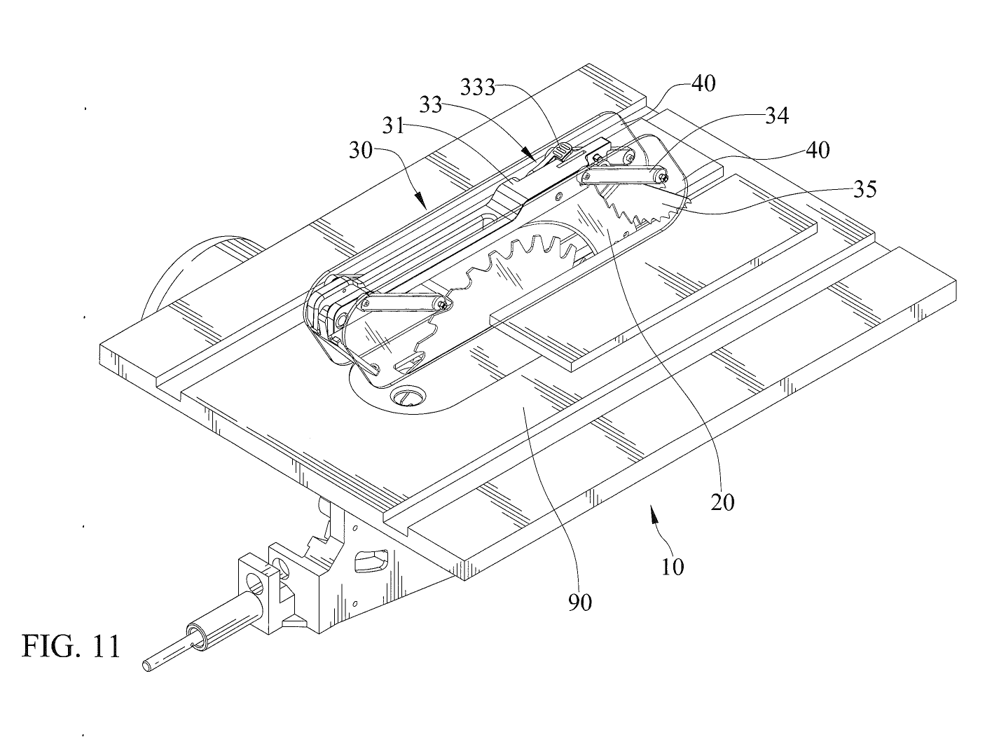

FIGS. 10 and 11 illustrate use of the detachable protective device 10 according to the present invention. When the user uses the table saw 90 to cut a board, the sawdust generated during cutting is stopped by the shields 40, maintaining a clean operation environment while avoiding the user from inhaling the sawdust. After the board has been cut into two pieces, the ratchet plates 35 abut top edges of the two pieces to avoid rearward movement, assuring smooth cutting.

In view of the foregoing, the user can rapidly mount and detach the detachable protective device 10 by simply pivoting the locking member 33 between the locking position and the release position. The operation is easy.

Although specific embodiments have been illustrated and described, numerous modifications and variations are still possible without departing from the scope of the invention. The scope of the invention is limited by the accompanying claims.

1. A detachable protective device for a table saw, comprising:
a cutter board including a top end having a first recess and a second recess, with the second recess including a receiving portion and a neck, with the receiving portion located in an inner side of the second recess, with the neck located in an outer side of the second recess, with the receiving portion having a first width, with the neck having a second width smaller than the first width;
a base mounted to the top end of the cutter board, with the base including a bracket, a pivot, and a locking member, with the bracket including a first hole and a second hole, with the pivot mounted in the first hole and releasably engaged with the first recess, with the locking member including a pivotal portion received in the second hole and releasably engaged with the second recess, with the locking member pivotable relative to the bracket between a locking position and a release position about a pivotal axis, with the pivotal portion having a maximal width orthogonal to the pivotal axis, with the maximal width larger than the second width and not larger than the first width, with the pivotal portion having a minimal width orthogonal to the pivotal axis, with the minimal width not larger than the second width, with the pivotal portion retained in the second recess when the locking member is in the locking position, with the pivotal portion capable of disengaging from the second recess when the locking member is in the release position, with the bracket further including an abutment portion, with the locking member further including a limiting portion, with the limiting portion abutting the abutment portion when the locking member is in the locking position, and with the limiting portion disengaged from the abutment portion when the locking member is in the release position; and
two shields mounted to two sides of the base.

2. The detachable protective device for a table saw as claimed in claim 1, with the bracket further including a receptacle, with an elastic element and a positioning member received in the receptacle, with the limiting portion of the locking member including a first positioning groove and a second positioning groove, with the positioning member biased by the elastic element to be selectively engaged with one of the first and second positioning grooves, with the positioning member engaged with the first positioning groove when the locking member is in the locking position, and with the positioning member engaged with the second positioning groove when the locking member is in the release position.

3. The detachable protective device for a table saw as claimed in claim 2, with the first hole parallel to the second hole, with the second hole formed in a side of the bracket, and with the abutment portion and the receptacle located on the side of the bracket.

4. The detachable protective device for a table saw as claimed in claim 1, wherein the pivotal portion includes two evasive faces, and wherein the minimal width is a spacing between the two evasive faces.

5. The detachable protective device for a table saw as claimed in claim 1, wherein the maximal width is equal to the first width, and wherein the minimal width is equal to the second width.

6. The detachable protective device for a table saw as claimed in claim 1, with the first recess located adjacent to a rear end of the cutter board, with the second recess located adjacent to a front end of the cutter board, and with each of the first and second recesses extending from a side of the cutter board through another side of the cutter board.

7. The detachable protective device for a table saw as claimed in claim 6, wherein the first recess is substantially L-shaped.

8. The detachable protective device for a table saw as claimed in claim 1, with the pivotal portion being substantially cylindrical, with the limiting portion located on an end of the pivotal portion, and with the locking member being integrally formed as a monolithic member.

9. The detachable protective device for a table saw as claimed in claim 1, with the base further including two arms pivotably mounted to two sides of the bracket, with each of the two arms having an end distant to the bracket, and with each of the two shields pivotably mounted to the end of one of the two arms.

10. The detachable protective device for a table saw as claimed in claim 1, with the base further including a ratchet plate pivotably mounted to each of two sides of the bracket.
